(19) United States
(12) Patent Application Publication
(10) Pub. No.: US 2012/0069370 A1
(43) Pub. Date: Mar. 22, 2012

(54) IMAGE INPUT OUTPUT APPARATUS

(76) Inventor: Hiroshi EGUCHI, Tokyo (JP)

(21) Appl. No.: 13/227,560

(22) Filed: Sep. 8, 2011

(30) Foreign Application Priority Data
Sep. 16, 2010 (JP) 2010-208593

(51) Int. Cl. G06K 15/02

(52) U.S. Cl. 358/1.13

(57) ABSTRACT

An image input output apparatus includes an image reading portion arranged to be freely opened and closed for reading an image and an image forming portion for forming a print image, so that the image input output apparatus capable of reading and printing the image. The image input output apparatus further includes a power supply portion for supplying power to each of the image reading portion and the image forming portion independently, and a detection portion for detecting whether the image reading portion is opened or closed. The power supply portion is arranged to become a first power save mode, in which the power supply portion reduces power supplied to the image reading portion when the detection portion detects that the image reading portion is opened.

### BACKGROUND OF THE INVENTION AND RELATED ART STATEMENT

The present invention relates to an image input output apparatus capable of reading and printing an image.

Recently, a conventional image input output apparatus such as a multifunction printer has become available. The conventional image input output apparatus may be provided with a scanner portion and a printer portion, and has an image reading function and an image forming function. In this case, the scanner portion is disposed above the printer portion. The scanner portion is configured to open entirely, so that maintenance of the printer portion and the scanner portion can be performed (for example, refer to Patent Reference).

Patent Reference: Japanese Patent Publication No. 2008-152050

In the conventional image input output apparatus, even when the scanner portion does not read an image, the scanner portion is still turned on, thereby wasting power.

In view of the problems described above, an object of the present invention is to provide an image input output apparatus capable of solving the problems of the conventional image input output apparatus.

Further objects and advantages of the invention will be apparent from the following description of the invention.

### SUMMARY OF THE INVENTION

In order to attain the objects described above, according to an aspect of the present invention, an image input output apparatus includes an image reading portion arranged to be freely opened and closed for reading an image and an image forming portion for forming a print image, so that the image input output apparatus capable of reading and printing the image. The image input output apparatus further includes a power supply portion for supplying power to each of the image reading portion and the image forming portion independently, and a detection portion for detecting whether the image reading portion is opened or closed. The power supply portion is arranged to become a first power save mode, in which the power supply portion reduces power supplied to the image reading portion when the detection portion detects that the image reading portion is opened.

According to the aspect of the present invention, the image input output apparatus includes the image reading portion arranged to be freely opened and closed for reading the image and the image forming portion for forming the print image, so that the image input output apparatus capable of reading and printing the image. The image input output apparatus further includes the power supply portion for supplying power to each of the image reading portion and the image forming portion independently, and the detection portion for detecting whether the image reading portion is opened or closed. The power supply portion is arranged to become the first power save mode, in which the power supply portion reduces power supplied to the image reading portion when the detection portion detects that the image reading portion is opened. Accordingly, it is possible to reduce unnecessary power consumption.

### BRIEF DESCRIPTION OF THE DRAWINGS

FIG. 1 is a schematic perspective view showing an image input output apparatus according to a first embodiment of the present invention;

FIG. 2 is a block diagram No. 1 showing a configuration of the image input output apparatus according to the first embodiment of the present invention;

FIG. 3 is a block diagram No. 2 showing the configuration of the image input output apparatus according to the first embodiment of the present invention;

FIGS. 4(a) and 4(b) are schematic side views showing an operation of the image input output apparatus according to the first embodiment of the present invention, wherein FIG. 4(a) is a schematic side view showing the image input output apparatus in a state that an image reading portion is closed, and FIG. 4(b) is a schematic side view showing the image input output apparatus in a state that the image reading portion is opened;

FIG. 5 is a flow chart showing the operation of the image input output apparatus according to the first embodiment of the present invention;

FIG. 6 is a block diagram No. 1 showing a configuration of an image input output apparatus according to a second embodiment of the present invention;

FIG. 7 is a block diagram No. 2 showing the configuration of the image input output apparatus according to the second embodiment of the present invention; and

FIG. 8 is a flow chart showing an operation of the image input output apparatus according to the second embodiment of the present invention.

### DETAILED DESCRIPTION OF PREFERRED EMBODIMENTS

Hereunder, embodiments of the present invention will be explained with reference to the accompanying drawings. Similar components in the drawings are designated with the same reference numerals.

### First Embodiment

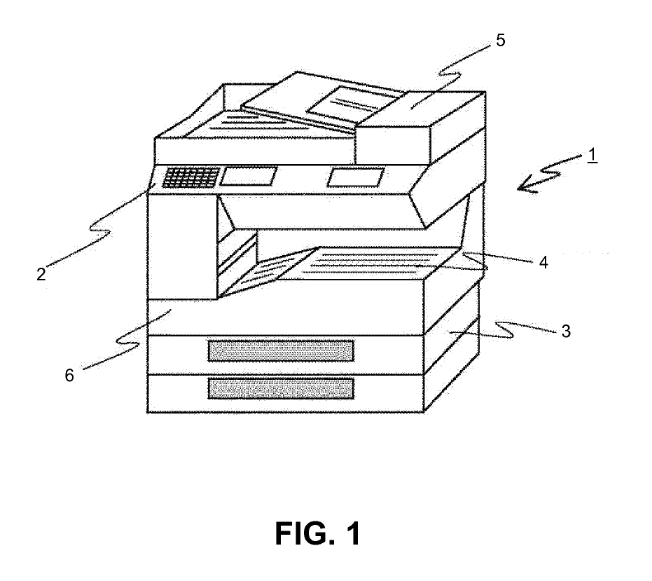

A first embodiment of the present invention will be explained. FIG. 1 is a schematic perspective view showing an image input output apparatus 1 according to the first embodiment of the present invention.

As shown in FIG. 1, the image input output apparatus 1 includes a scanner portion 5 at an upper portion thereof. The scanner portion 5 corresponds to an image reading portion 12 (described later). Further, the image input output apparatus 1 includes an operation portion 2 at an upper front surface thereof for performing a start instruction of a copier printing operation and various setting operations such as settings of a print number, a density, a size, and the like.

In the embodiment, the image input output apparatus 1 further includes a sheet supply cassette 3 with a multiple stages at a lower portion thereof. The sheet supply cassette 3 is configured such that each of the stages can be pulled out with a handle thereof. Further, the image input output apparatus 1 includes a printer portion 6 at an upper portion thereof. The printer portion 6 corresponds to an image forming portion 14 (described later). A sheet discharge portion 4 is disposed above the printer portion 6, so that a sheet supplied from the sheet supply cassette 3 is discharged on the sheet discharge portion 4 after an image is formed on the sheet.

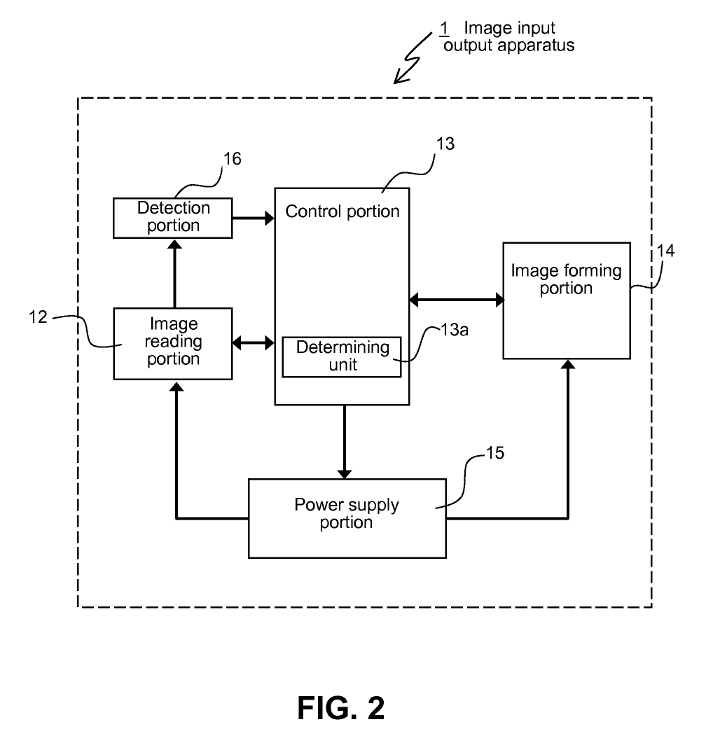

FIG. 2 is a block diagram No. 1 showing a configuration of the image input output apparatus 1 according to the first embodiment of the present invention.

As shown in FIG. 2, the image input output apparatus 1 includes the image reading portion 12 corresponding to the scanner portion 5; a control portion 13; the image forming portion 14; a power supply portion 15; and a detection portion 16. It is noted that the control portion 13, the image forming portion 14, the power supply portion 15, and the detection portion 16 constitute the printer portion 6.

In the embodiment, the image reading portion 12 has a function of reading an original to obtain image information. The image forming portion 14 has a function of performing a printing operation according to the image information received under control of the control portion 13.

In the embodiment, the power supply portion 15 is configured to be able to supply power to each component of the image input output apparatus 1 independently. The power supply portion 15 has a normal power supply mode and a first power save mode. In the normal power supply mode, the power supply portion 15 supply power to all of the components. In the first power save mode, the power supply portion 15 reduces power supplied to the image reading portion 12.

In the embodiment, the image reading portion 12 or the scanner portion 5 is configured such that the image reading portion 12 can be opened on a side of the operation portion 2 in FIG. 1. The detection portion 16 has a function of detecting whether the image reading portion 12 is opened or closed.

In the embodiment, the control portion 13 includes a determining unit 13a for instructing the power supply portion 15 to switch between the normal power supply mode and the first power save mode. For example, when the determining unit 13a determines that the detection portion 16 detects that the scanner portion 5 is opened, the determining unit 13a instructs the power supply portion 15 to switch to the first power save mode.

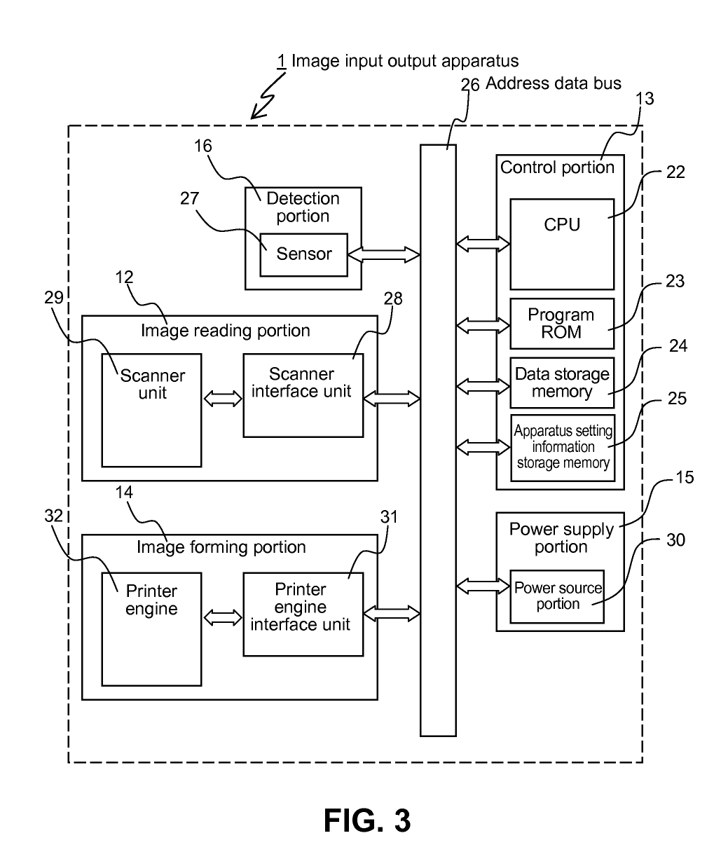

The configuration of the image input output apparatus 1 will be explained in more detail with reference to FIG. 3. FIG. 3 is a block diagram No. 2 showing the configuration of the image input output apparatus 1 according to the first embodiment of the present invention.

As shown in FIG. 3, the control portion 13 includes a CPU (Central Processing Unit) 22, a program ROM (Read Only Memory) 23, a data storage memory 24, and an apparatus setting information storage memory 25. The CPU 22 is provided for controlling each component of the image input output apparatus 1 and administering a flow of the image information. The program ROM 23 is provided for storing control program data.

In the embodiment, the data storage memory 24 is provided for storing the image information, and the apparatus setting information storage memory 25 is provided for storing an operation parameter of the image input output apparatus 1 such as a parameter for switching to the first power save mode. The CPU 22 reads necessary information through an address data bus 26, so that the information is stored in the apparatus setting information storage memory 25.

In the embodiment, the CPU 22 corresponds to the determining unit 13a of the control portion 13 shown in FIG. 2, and is provided for instructing a power source portion 30 of the power supply portion 15 to switch to various power save modes. The power source portion 30 is configured to supply power to each component in the image input output apparatus 1 independently. More specifically, the power source portion 30 is configured to supply power to all of the components in the normal power supply mode, and to reduce power to the image reading portion 12 in the first power save mode. The power source portion 30 may be configured to stop power in the first power save mode, thereby reducing the power consumption. The power source portion 30 switches between the normal power supply mode and the first power save mode according to an instruction of the CPU 22.

In the embodiment, the image reading portion 12 includes a scanner interface unit 28 and a scanner unit 29. The scanner unit 29 is configured to be able to communicate with the CPU 22 through the scanner interface unit 28, so that the scanner unit 29 reads the original placed on an upper portion of the scanner portion 5 according to an instruction of the CPU 22, thereby obtaining the image information. The scanner unit 29 and the scanner interface unit 28 constitute the image reading portion 12.

In the embodiment, the image forming portion 14 includes a printer engine interface unit 31 and a printer engine 32. The printer engine interface unit 31 is an interface circuit provided for transferring the image information to the printer engine 32 according to an instruction of the CPU 22, and for receiving and transmitting a control signal. The printer engine 32 is provided for performing the printing operation on the sheet according to the image information thus received. The printer engine interface unit 31 and the printer engine 32 constitute the image forming portion 14.

In the embodiment, a sensor 27 constitutes the detection portion 16 for detecting whether the scanner unit 29 is opened or closed. The CPU 22 reads information of the sensor 27.

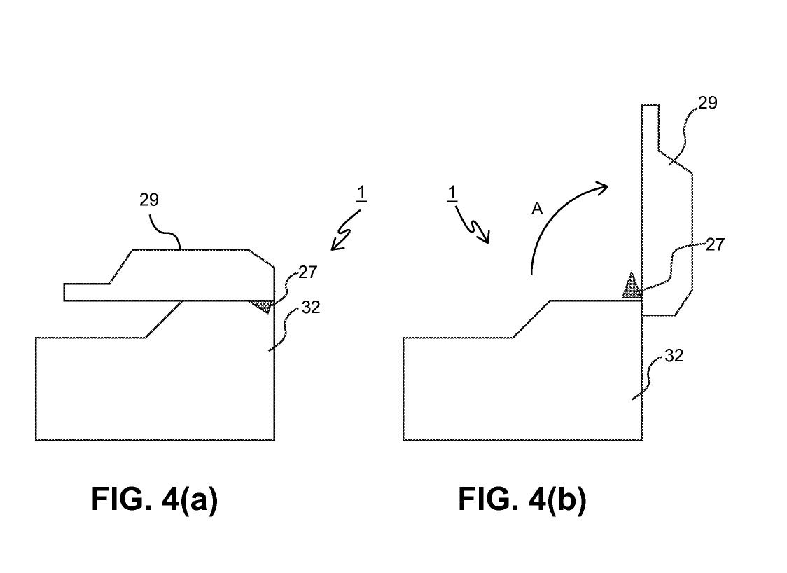

An operation of the image input output apparatus 1 will be explained next with reference to FIGS. 4(a) and 4(b). FIGS. 4(a) and 4(b) are schematic side views showing the operation of the image input output apparatus 1 according to the first embodiment of the present invention. More specifically, FIG. 4(a) is a schematic side view showing the image input output apparatus 1 in a state that the scanner unit 29 disposed above the printer engine 32 is closed. The sensor 27 detects a sensor-on in this state. FIG. 4(b) is a schematic side view showing the image input output apparatus 1 in a state that the scanner unit 29 is opened in an arrow direction A. The sensor 27 detects a sensor-off in this state.

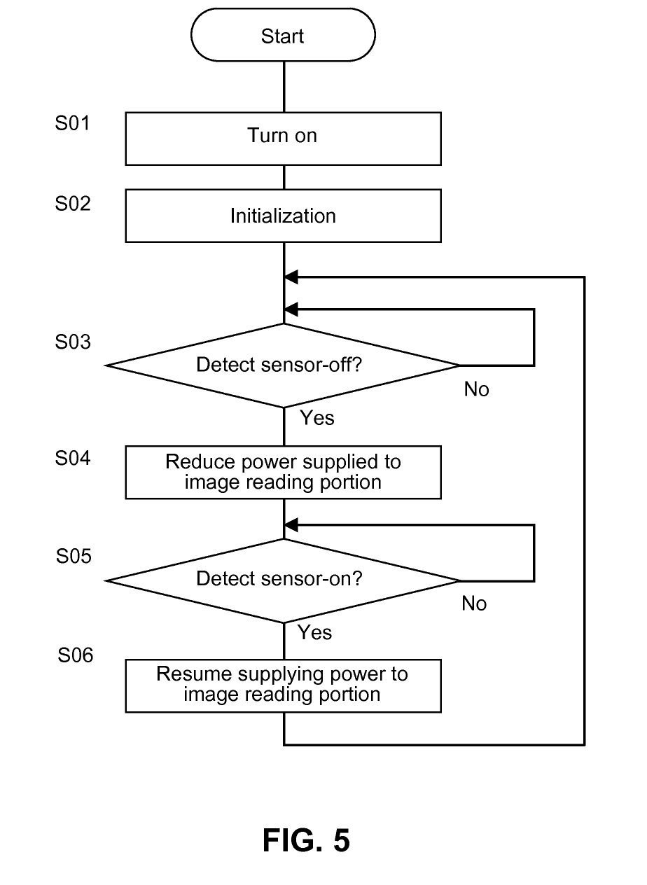

The operation of the image input output apparatus 1 will be explained in more detail next with reference to a flow chart shown in FIG. 5. FIG. 5 is the flow chart showing the operation of the image input output apparatus 1 according to the first embodiment of the present invention.

In step S01, the image input output apparatus 1 is turned on. Accordingly, the power source portion 30 supplies power to each component of the image input output apparatus 1. In step S02, the CPU 22 performs initialization of each peripheral LSI and each memory, and performs printing operation preparation control through the printer engine interface unit 31. Further, the CPU 22 becomes capable of communicating with the scanner unit 29 through the scanner interface unit 28, and the image input output apparatus 1 is in an idle state. It is noted that this state corresponds to the normal power supply mode.

In step S03, the CPU 22 monitors the sensor 27 to determine whether the sensor 27 detects the sensor-off. When the CPU 22 determines that the sensor 27 does not detect the sensor-off, the CPU 22 determines that the scanner unit 29 is closed as shown in FIG. 4(a), and continues monitoring the sensor 27. When the CPU 22 determines that the sensor 27 detects the sensor-off, the CPU 22 determines that the scanner unit 29 is opened as shown in FIG. 4(b).

In step S04, the CPU 22 controls the power source portion 30 to reduce power supplied to the image reading portion 12, that is, the scanner interface unit 28 and the scanner unit 29. It is noted that this state corresponds to the first power save mode. In the first power save mode, the power source portion 30 continues supplying power to the components other than the scanner interface unit 28 and the scanner unit 29. Accordingly, the components with power supplied thereto are operational.

In step S05, the CPU 22 monitors the sensor 27 to determine whether the sensor 27 detects the sensor-on. When the CPU 22 determines that the sensor 27 still detects the sensor-off, the CPU 22 determines that the scanner unit 29 is still opened as shown in FIG. 4(b), and continues monitoring the sensor 27. When the CPU 22 determines that the sensor 27 detects the sensor-on, the CPU 22 determines that the scanner unit 29 is closed as shown in FIG. 4(a).

In step S06, the CPU 22 controls the power source portion 30 to resume supplying power to the scanner interface unit 28 and the scanner unit 29, which constitute the image reading portion 12. As a result, the power source portion 30 supplies power to all of the components of the image input output apparatus 1, so that all of the components become operational. It is noted that this state corresponds to the normal power supply mode. The process returns to step S03, and is repeated thereafter.

As explained above, in the embodiment, when the scanner unit 29 is opened and not perform the scanner operation, the power source portion 30 reduce power supplied to the scanner unit 29, and supplies power to the components other than the scanner unit 29. Accordingly, it is possible to reduce power consumption, and still it is possible to perform the image forming operation to print the image thus read.

As explained above, in the embodiment, the image input output apparatus 1 includes the detection portion 16 for detecting whether the scanner unit 29 is opened or closed, and the power supply portion 15 for supplying power to each component of the image input output apparatus 1 independently. When the detection portion 16 detects that the scanner unit 29 is opened, the power supply portion 15 reduces power supplied to the scanner unit 29. Accordingly, it is possible to reduce unnecessary power consumption.

### Second Embodiment

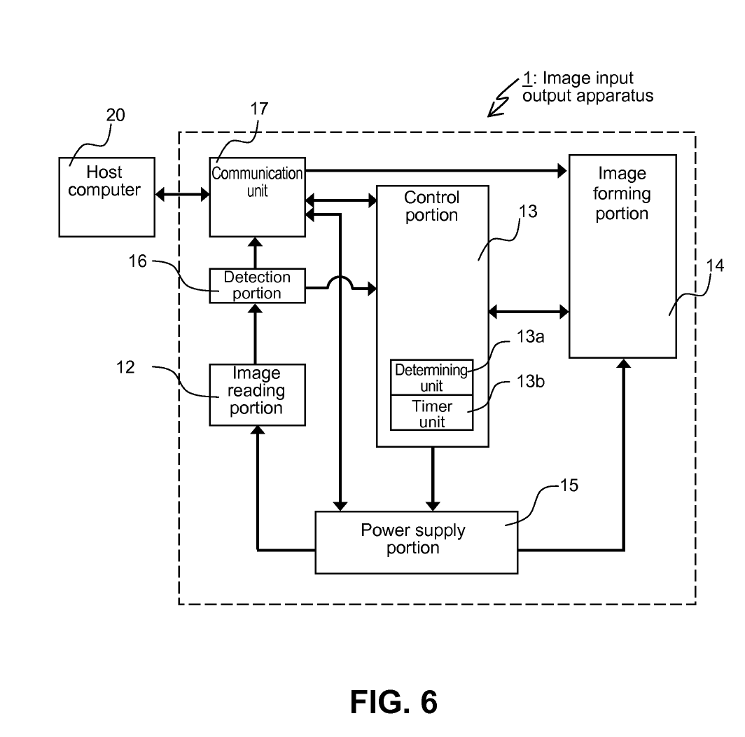

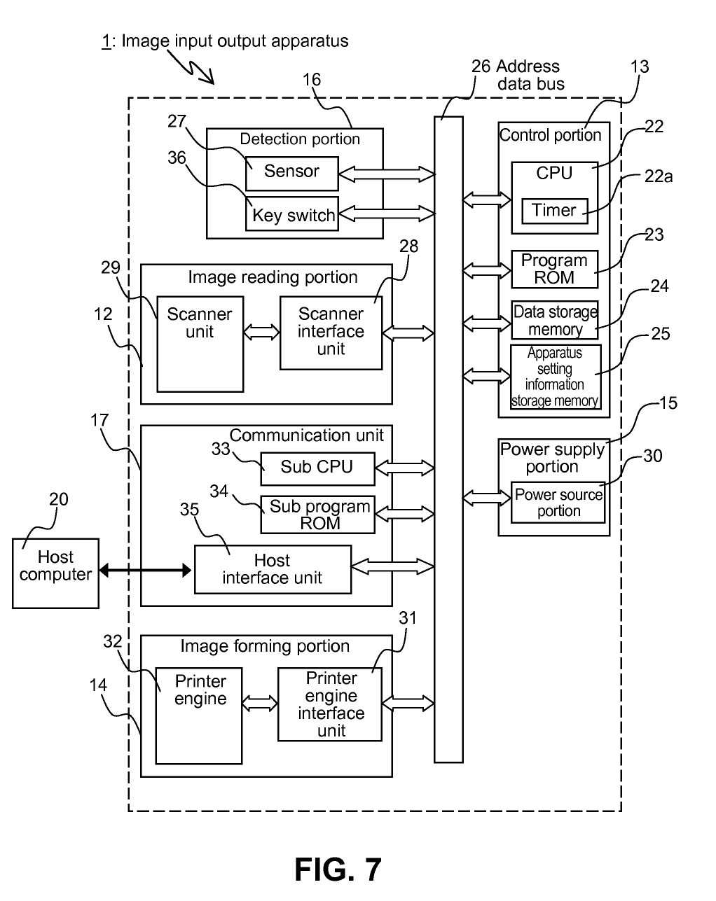

A second embodiment of the present invention will be explained next. FIG. 6 is a block diagram No. 1 showing a configuration of the image input output apparatus 1 according to the second embodiment of the present invention. FIG. 7 is a block diagram No. 2 showing the configuration of the image input output apparatus 1 according to the second embodiment of the present invention.

As shown in FIGS. 6 and 7, in the image input output apparatus 1 in the second embodiment, the control portion 13 further includes a timer unit 13b. More specifically, the CPU 22 further includes a timer 22a for measuring a specific period of time.

In the embodiment, the power source portion 30 is configured to supply power to all of the components independently. As explained above, in the first embodiment, the power source portion 30 supplies power to all of the components in the normal power supply mode, and reduces power supplied to the image reading portion 12 in the first power save mode. In addition to the normal power supply mode and the first power save mode, in the second embodiment, it is possible to set a second power save mode and a third power save mode. In the second power save mode, the power source portion 30 reduces power supplied to the image forming portion 14. In the third power save mode, the power source portion 30 supplies power only to the detection portion 16 and a communication unit 17. The power source portion 30 may be configured to stop power in the second power save mode and the third power save mode, thereby reducing the power consumption.

In the embodiment, the image input output apparatus 1 includes the communication unit 17 for communicating with an external device. The communication unit 17 is formed of a sub CPU 33, a sub program ROM 34, and a host interface unit 35. The CPU 22 is configured to be able to communicate with a host computer through the host interface unit 35 in the communication unit 17. The host interface unit 35 is an interface compliant with a standard such as USB 2.0, IEEE 1284, IEEE 1394, and Ethernet (a trademark), so that the host interface unit 35 receives the image information from the host computer 20 according to the standard.

In the embodiment, the sub CPU 33 is provided for controlling the printer engine 32 when the power source portion 30 supplies power to the image forming portion 14 in the normal power supply mode or the first power save mode. More specifically, the sub CPU 33 controls a motor and various sensors of the printer engine 32 through the printer engine interface unit 31. The program ROM 23 is provided for storing control program data.

Further, the sub CPU 33 is provided for controlling the host interface unit 35 when the power source portion 30 supplies power only to the communication unit 17 and the detection portion 16 in the third power save mode, so that the sub CPU 33 is capable of communicating with the host computer 20 through the host interface unit 35. The sub program ROM 34 is provided for storing control program data.

In the embodiment, the sub CPU 33 is configured to consume less power than the CPU 22. Accordingly, when the image input output apparatus 1 in the third power save mode, it is possible to minimize the power consumption of the image input output apparatus 1. The CPU 22 and the sub CPU 33 instruct the power source portion 30 to switch between the normal power supply mode, the first power save mode, the second power save mode, and the third power same mode. Accordingly, the power source portion 30 switches between the normal power supply mode, the first power save mode, the second power save mode, and the third power same mode.

In the embodiment, in the image input output apparatus 1, the detection portion 16 includes a key switch 36. When the user operates the key switch 36, it is possible to return from one of the first power save mode, the second power save mode, and the third power same mode to the normal power supply mode. The CPU 22 and the sub CPU 33 are configured to confirm the return to the normal power supply mode. It is noted that it is not necessary to provide the key switch 36 when it is not necessary to forcibly return from one of the first power save mode, the second power save mode, and the third power same mode to the normal power supply mode.

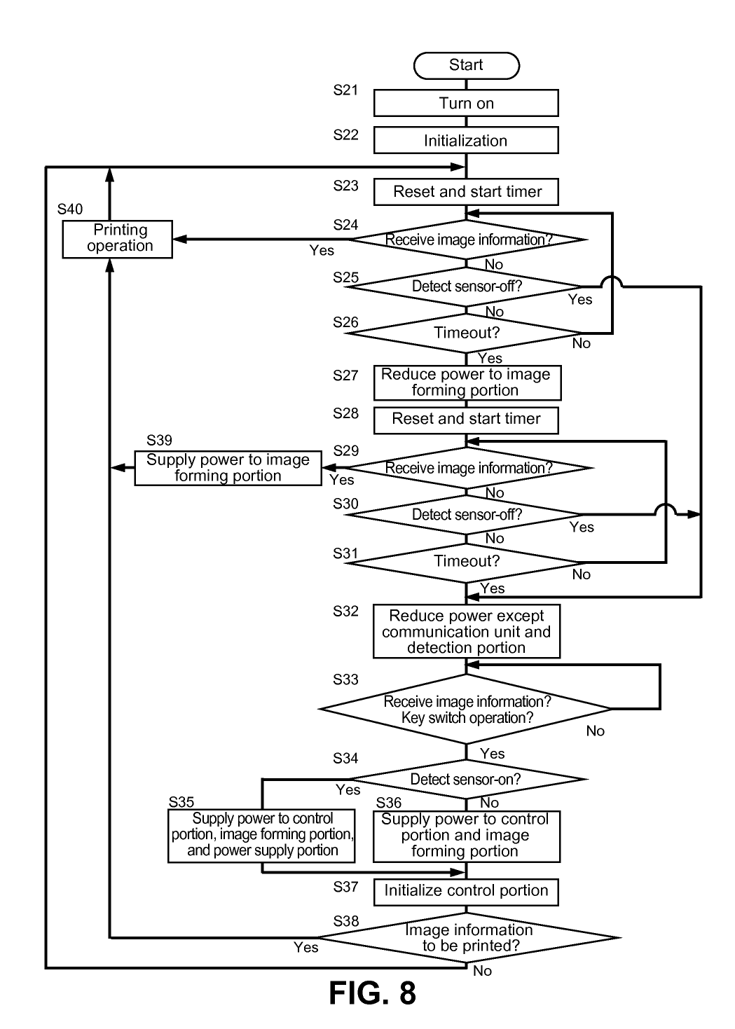

An operation of the image input output apparatus 1 will be explained next with reference to a flow chart shown in FIG. 8. FIG. 8 is the flow chart showing the operation of the image input output apparatus 1 according to the second embodiment of the present invention.

In step S21, the image input output apparatus 1 is turned on. Accordingly, the power source portion 30 supplies power to each component of the image input output apparatus 1. In step S22, the CPU 22 performs initialization of each peripheral LSI and each memory, and the sub CPU 33 performs printing operation preparation control through the printer engine interface unit 31. Further, the CPU 22 becomes capable of communicating with the host computer 20 through the host interface unit 35, and the image input output apparatus 1 is in an idle state. It is noted that this state corresponds to the normal power supply mode.

In step S23, after the CPU 22 resets the timer 22a functioning as a power save mode transition time measurement timer, the CPU 22 starts the timer 22a. In step S24, the CPU 22 determines whether the image information is received through the host interface unit 35 and the scanner interface unit 28. When the CPU 22 determines that the image information is not received, the process proceeds to step S25. When the CPU 22 determines that the image information is received, the process proceeds to step S40. In step S40, the CPU 22 transfers the image information to the printer engine 32 through the printer engine interface unit 31, thereby performing the printing operation.

In step S25, when the CPU 22 determines that the image information is not received in step S23, the CPU 22 monitors the sensor 27 to determine whether the sensor 27 detects the sensor-off. When the CPU 22 determines that the sensor 27 does not detect the sensor-off, the CPU 22 determines that the scanner unit 29 is closed as shown in FIG. 4(a), and the process proceeds to step S26. When the CPU 22 determines that the sensor 27 detects the sensor-off, the CPU 22 determines that the scanner unit 29 is opened as shown in FIG. 4(b), and the process proceeds to step S32.

In step S26, when the CPU 22 determines that the sensor 27 does not detect the sensor-off in step S25, the CPU 22 monitors the power save mode transition time measurement timer to determine whether a first period of time is elapsed for the power save mode transition (timeout). The power save mode transition time is stored in the apparatus setting information storage memory 25. When the CPU 22 determines that the first period of time is not elapsed and it is not timeout, the process returns to step S24. When the CPU 22 determines that the first period of time is elapsed and it is timeout, the process proceeds to step S27.

In step S27, when the CPU 22 determines that the first period of time is elapsed and it is timeout, the CPU 22 controls the power source portion 30 to reduce power supplied to the image forming portion 14, that is, the printer engine interface unit 31 and the printer engine 32. It is noted that this state corresponds to the second power save mode, thereby reducing the power consumption.

In step S28, after the CPU 22 resets the timer 22a functioning as the power save mode transition time measurement timer, the CPU 22 starts the timer 22a again. In step S29, the CPU 22 determines whether the image information is received through the host interface unit 35 and the scanner interface unit 28. When the CPU 22 determines that the image information is not received, the process proceeds to step S30. When the CPU 22 determines that the image information is received, the process proceeds to step S39. In step S39, the CPU 22 controls the power source portion 30 to supply power to the image forming portion 14, that is, the printer engine interface unit 31 and the printer engine 32. Then, the process proceeds to step S40. In step S40, the CPU 22 transfers the image information to the printer engine 32 through the printer engine interface unit 31, thereby performing the printing operation. Then, the process returns to step S23.

In step S30, the CPU 22 monitors the sensor 27 to determine whether the sensor 27 detects the sensor-off. When the CPU 22 determines that the sensor 27 does not detect the sensor-off (is in the on state), the CPU 22 determines that the scanner unit 29 is closed as shown in FIG. 4(a), and the process proceeds to step S31. When the CPU 22 determines that the sensor 27 detects the sensor-off (becomes the off state), the CPU 22 determines that the scanner unit 29 is opened as shown in FIG. 4(b), and the process proceeds to step S32.

In step S31, the CPU 22 monitors the power save mode transition time measurement timer to determine whether a second period of time is elapsed for the power save mode transition (timeout). When the CPU 22 determines that the second period of time is not elapsed and it is not timeout, the process returns to step S29. When the CPU 22 determines that the second period of time is elapsed and it is timeout, the process proceeds to step S32.

In the next step, the CPU 22 controls the sub CPU 33 to initialize the sub program ROM 34, and stops controlling the scanner unit 29 and resets the sub CPU 33. Afterward, the sub CPU 33 starts with the program stored in the sub program ROM 34, and starts controlling the host interface unit 35.

In step S32, the sub CPU 33 controls the power source portion 30 to reduce power supplied to the CPU 22, the program ROM 23, the data storage memory 24, the apparatus setting information storage memory 25 and the scanner interface unit 28 of the control portion 13, the scanner unit 29 of the image reading portion 12, and the printer engine interface unit 31 and the printer engine 32 of the image forming portion 14 except the communication unit 17 and the detection portion 16. It is noted that this state corresponds to the third power save mode, thereby reducing the power consumption further than the second power save mode.

In step S33, the sub CPU 33 determines whether the image information is received through the host interface unit 35 and the scanner interface unit 28, or the key switch 36 is operated. When the sub CPU 33 determines that the image information is not received and the key switch 36 is operated, the sub CPU 33 waits until the image information is not received and the key switch 36 is operated. When the sub CPU 33 determines that the image information is received, or the key switch 36 is operated, the process proceeds to step S34.

In step S34, when the sub CPU 33 determines that the image information is received, or the key switch 36 is operated in step S33, the sub CPU 33 monitors the sensor 27 to determine whether the sensor 27 detects the sensor-off. When the sub CPU 33 determines that the sensor 27 does not detect the sensor-off (in the on state), the sub CPU 33 determines that the scanner unit 29 is closed as shown in FIG. 4(a), and the process proceeds to step S36. When the sub CPU 33 determines that the sensor 27 detects the sensor-off (in the off state), the sub CPU 33 determines that the scanner unit 29 is opened as shown in FIG. 4(b), and the process proceeds to step S35.

In step S35, the sub CPU 33 controls the power source portion 30 to supply power to all of the components in the image input output apparatus 1, that is, the control portion 13, the image forming portion 14, and the power supply portion 15. It is noted that this state corresponds to the normal power supply mode, thereby increasing the power consumption. In step S36, the sub CPU 33 controls the power source portion 30 to supply power to the components in the image input output apparatus 1 except the image reading portion 12, that is, the control portion 13 and the image forming portion 14, so that the image input output apparatus 1 is capable of performing the printing operation. It is noted that this state corresponds to the first power save mode.

In step S37, the CPU 22 starts and the control portion 13 is initialized, so that the image input output apparatus 1 becomes capable of processing. Accordingly, the CPU 22 starts communicating with the sub CPU 33 to take over the data processing of the host interface unit 35. When the CPU 22 takes over the data processing from the sub CPU 33, the CPU 22 controls the sub CPU 33 to initialize with the program ROM 23, thereby resetting the sub CPU 33. Afterward, the sub CPU 33 starts with the program stored in the program ROM 23, so that the sub CPU starts controlling the printer engine 32 through the printer engine interface unit 31.

In step S38, it is determined whether there is the image information to be printed. When it is determined that there is the image information to be printed, it is determined that the image information is received, not the key switch 36 is operated in step S33, and the process proceeds to step S40. After the printing operation of the image information is performed, the process returns to step S23.

When it is determined that there is not the image information to be printed, it is determined that the key switch 36 is operated by the operator to return to one of the first power save mode, the second power save mode, and the third power save mode in step S33, and the process returns to step S23 without performing the printing operation control of the image information.

In the embodiment, when the scanner unit 29 is in the closed state, and the image information is not received in the idle state for the first period of time, the power source portion 30 reduces power supplied to the image forming portion 14 in the second power save mode. Further, when the idle state continues for the second period of time, the power source portion 30 reduces power supplied to the components other than the detection portion 16 and the communication unit 17 in the third power save mode. Alternatively, steps S26 to S30 and step S39 may be skipped so that the power source portion 30 continues supplying power to the image forming portion 14. Further, when the idle state continues for the first period of time and the second period of time, the normal power supply mode is switched to the third power save mode.

As explained above, in the second embodiment, the image input output apparatus 1 includes the sensor 27 for detecting whether the scanner unit 29 is opened or closed; the timer 22a for measuring the idle state in which the scanner unit 29 is closed and the image information is not received; and the key switch 36 for instructing the return from the normal power supply mode. Further, it is configured to provide the second power save mode for reducing power to the image forming portion 14 and the third power save mode for reducing power supplied to the components other than the detection portion 16 and the communication unit 17.

Further, in the second embodiment, when the idle state continues for the first period of time, power supplied to the components other than the image forming portion 14 is reduced in the second power save mode. Further, when the idle state continues for the second period of time, or the detection portion 16 detects that the image reading portion 12 is opened, power is supplied only to the detection portion 16 and the communication unit 17 in the third power save mode. Accordingly, it is possible to further reduce unnecessary power consumption.

It is noted that the present invention is applicable to the image input output apparatus such as a facsimile, a copier, a multifunction product, and the like capable of reading and printing the image.

The disclosure of Japanese Patent Application No. 2010-208593, filed on Sep. 16, 2010, is incorporated in the application by reference.

While the invention has been explained with reference to the specific embodiments of the invention, the explanation is illustrative and the invention is limited only by the appended claims.

What is claimed is:

1. An image input output apparatus, comprising:
an image reading portion arranged to be freely opened and closed for reading an image;
an image forming portion for forming the image;
a power supply portion for supplying power to each of the image reading portion and the image forming portion independently; and
a detection portion for detecting whether the image reading portion is opened or closed,
wherein said power supply portion is arranged to reduce power supplied to the image reading portion in a first power save mode when the detection portion detects that the image reading portion is opened.

2. The image input output apparatus according to claim 1, further comprising a communication portion for receiving image information from an external device, and a timer portion for measuring a period of time during which the image reading portion is opened and the communication portion does not receive the image information, wherein said power supply portion is arranged to reduce power supplied to the image forming portion in a second power save mode when the period of time exceeds a first period of time, and said power supply portion is arranged to supply power only to the communication portion and the detection portion in a third power save mode when the period of time exceeds a second period of time or the detection portion detects that the image reading portion is opened.

3. The image input output apparatus according to claim 2, further comprising a key switch for returning to a normal power supply mode, wherein said power supply portion is arranged to switch to the normal power supply mode or the first power save mode from the third power save mode when the communication portion receives the image information or the key switch is operated according to whether the image reading portion is opened or closed.

4. The image input output apparatus according to claim 1, wherein said power supply portion is arranged to terminate the first power save mode and resume supplying power to the image reading portion when the detection portion detects that the image reading portion is closed.

5. The image input output apparatus according to claim 4, further comprising a communication portion for receiving image information from an external device, and a timer portion to be reset after a printing operation is performed, wherein said power supply portion is arranged to reduce power supplied to the image reading portion and the image forming portion when a specific period of time is elapsed after the timer portion is reset.

6. The image input output apparatus according to claim 5, wherein said power supply portion is arranged to reduce power supplied to the image reading portion and resume supplying power to the image forming portion, and the timer portion is reset when the communication portion receives the image information and the detection portion detects that the image reading portion is opened.

7. The image input output apparatus according to claim 6, wherein said power supply portion is arranged to resume supplying power to the image reading portion and the image forming portion, and the timer portion is reset when the communication portion receives the image information and the detection portion detects that the image reading portion is closed.
